(19) United States
(12) Patent Application Publication
(10) Pub. No.: US 2024/0210545 A1
(43) Pub. Date: Jun. 27, 2024

(54) LIDAR SYSTEM, AN APPARATUS AND A PROCESSING METHOD IN ASSOCIATION THERETO

(71) Applicant: Continental Autonomous Mobility US, LLC, Auburn Hills, MI (US)

(72) Inventor: Horst W Wagner, Goleta, CA (US)

(73) Assignee: Continental Autonomous Mobility US, LLC, Auburn Hills, MI (US)

(21) Appl. No.: 18/086,295

(22) Filed: Dec. 21, 2022

(51) Int. Cl. G01S 7/52

(52) U.S. Cl. CPC G01S 7/52087

(57) ABSTRACT

In accordance with an aspect of the disclosure, there is provided a processing method. The processing method may be suitable for facilitating synchronization between an active device and a passive device, in accordance with an embodiment of the disclosure. The processing method may, for example, include a coarse synchronization step and a fine synchronization step, in accordance with an embodiment of the disclosure. The coarse synchronization step may, for example, include performing a first set of processing tasks to perform the tasks of communicating light from the active device toward a target and initiating capturing of light reflected from the target by the passive device. The fine synchronization step may, for example, include performing a second set of processing tasks to perform the task of matching as between the active device and the passive device in a manner so as to determine at least one fine-tuning factor.

### BACKGROUND

Typically, LIDAR (“light detection and ranging” or “laser imaging detection and ranging”) may be utilized for the purpose of measurement of flight, which may be direct or indirect, in association with distance to one or more objects so as to obtain distance information. Such distance information may be usable for guiding vehicles for applications such as automated and assisted driving in connection with, for example, urban driving.

Appreciably, for urban driving, it may be necessary to obtain at least an adequate overview (e.g., a complete overview such as a 360-degree overview) of the surrounding in connection with the guided vehicle(s). Such overview may be provided via the use of one or more LIDAR-based systems (e.g., one or more LIDAR cameras). For example, a rotating LIDAR camera may be carried by a vehicle, or a plurality of LIDAR cameras may be carried by a vehicle.

Conventionally, in the case where a vehicle carries a plurality of LIDAR cameras, each LIDAR camera would operate independently (i.e., the LIDAR cameras would operate independently of each other). For example, light emitted by a LIDAR camera would not be captured by another LIDAR camera. The present disclosure contemplates that this may not be optimal/efficient, and it would be helpful to address (or at least mitigate) such an issue/issues.

The background description provided herein is for the purpose of generally presenting the context of the disclosure. Work of the presently named inventors, to the extent it is described in this background section, as well as aspects of the description that may not otherwise qualify as prior art at the time of filing, are neither expressly nor impliedly admitted as prior art against the present disclosure.

### BRIEF SUMMARY

In accordance with embodiment(s) of the disclosure, there is provided an apparatus.

The apparatus may, for example, be suitable for facilitating synchronization of an active device (e.g., a first LIDAR device such as a first LIDAR camera) and a passive device (e.g., a second LIDAR device such as a second LIDAR camera), in accordance with an embodiment of the disclosure. The apparatus may, for example, include a processor which may be coupled to one or both of the active device and the passive device, in accordance with an embodiment of the disclosure. The processor may, for example, be configured to perform one or both of a first set of processing tasks and a second set of processing tasks, in accordance with an embodiment of the disclosure. The first set of processing tasks may, for example, be associated with a first synchronization stage and the second set of processing tasks may, for example, be associated with a second synchronization stage. In one embodiment, the first synchronization stage may be associated with coarse synchronization of the active device and passive device. Moreover, coarse synchronization may, for example, include coarse time synchronization of the active and passive devices, in accordance with an embodiment of the disclosure. In one embodiment, the second synchronization stage may be associated with fine synchronization of the active device and passive device. Moreover, fine synchronization may, for example, include fine time synchronization of the active and passive devices, in accordance with an embodiment of the disclosure

In accordance with embodiment(s) of the disclosure, there is provided a processing method.

The processing method may, for example, be suitable for facilitating synchronization between an active device (e.g., a first LIDAR device such as a first LIDAR camera) and a passive device (e.g., a second LIDAR device such as a second LIDAR camera), in accordance with an embodiment of the disclosure. The processing method may, for example, include a coarse synchronization step and a fine synchronization step, in accordance with an embodiment of the disclosure. The coarse synchronization step may, for example, include performing a first set of processing tasks to perform the tasks of communicating light from the active device toward a target and initiating capturing of light reflected from the target by the passive device. The fine synchronization step may, for example, include performing a second set of processing tasks to perform the task of matching as between the active device and the passive device in a manner so as to determine at least one fine-tuning factor.

Other objects, features and characteristics, as well as the methods of operation (where/if applicable) and the functions of the related elements of the structure, the combination of parts and economics of manufacture will become more apparent upon consideration of the following detailed description and appended claims with reference to the accompanying drawings, all of which form a part of this specification. It should be understood that the detailed description and specific examples, while indicating the non-limiting embodiments of the disclosure, are intended for purposes of illustration only and are not intended to limit the scope of the disclosure.

### BRIEF DESCRIPTION OF THE DRAWINGS

The present disclosure will become more fully understood from the detailed description and the accompanying drawings, wherein:

FIG. 1a depicts a LIDAR system which may include one or more LIDAR devices, according to an embodiment of the disclosure;

FIG. 1b depicts an example implementation in association with the LIDAR system of FIG. 1a, according to an embodiment of the disclosure;

FIG. 2 depicts an example synchronization strategy in association with the example implementation of FIG. 1b, according to an embodiment of the disclosure; and

FIG. 3 depicts a processing method in association with the LIDAR system of FIG. 1a, according to an embodiment of the disclosure.

### DETAILED DESCRIPTION

It should be understood that like reference numerals identify corresponding or similar elements throughout the several drawings. It should be understood that although a particular component arrangement is disclosed and illustrated in these exemplary embodiments, other arrangements could also benefit from the teachings of this disclosure.

It is generally contemplated that for a vehicle which may be equipped with a plurality of LIDAR cameras (e.g., four LIDAR cameras), each LIDAR camera may be required to have at least 180-degree field of view for adequate coverage (i.e., of the surrounding in connection with the vehicle). Appreciably, in terms of coverage by two LIDAR cameras, one or more overlap areas (i.e., overlap coverage area(s)) may be possible.

The present disclosure contemplates that such overlap area(s) could, for example, be associated with (additional/more) ranging information (e.g., additional ranging information which may not have been captured by a LIDAR camera individually). For example, the possibility of light transmitted/emitted/communicated by one LIDAR camera (e.g., a first LIDAR camera) may be captured by another LIDAR camera (e.g., a second LIDAR camera) leading to additional ranging information is contemplated.

It is contemplated that one possible issue to address may be the possible necessity for synchronization. Specifically, in one example, the first and second LIDAR cameras may need to be synchronized for ensuring/obtaining/measuring/deriving a reasonably adequate accurate (preferably accurate) time of flight measurement. One possible approach for synchronizing the LIDAR cameras may, for example, be by use of one or more dedicated optical fibers. The present disclosure contemplates that such use of dedicated optical fiber(s) may lead to possible complexities/inefficiencies (e.g., in terms of system design and system cost etc.).

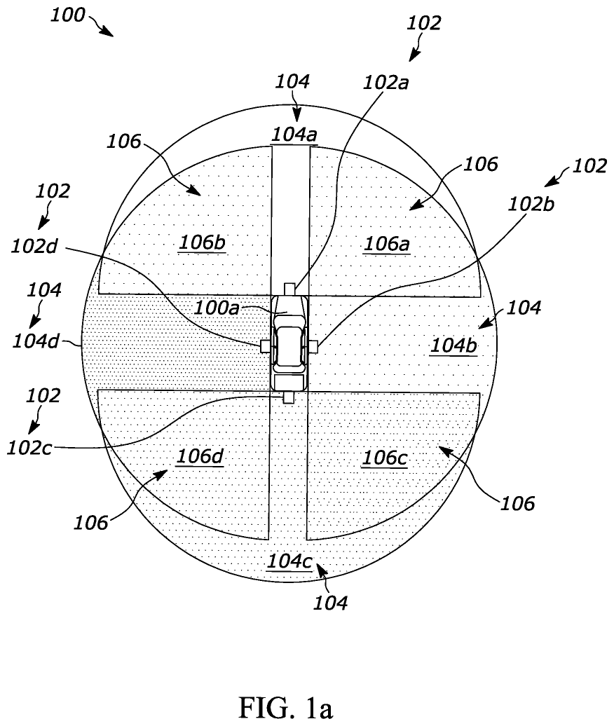

The present disclosure contemplates that it may be helpful to at least particularly address (preferably, fully address) one or more issues associated with synchronization, as will be discussed in further detail with reference to FIG. 1 to FIG. 3 hereinafter.

Referring to FIG. 1a and FIG. 1b, a LIDAR (“light detection and ranging” or “laser imaging detection and ranging”) system 100 is shown in accordance with an embodiment of the disclosure. The LIDAR system 100 may, for example, be suitable for use in association with a vehicle 100a.

Referring to FIG. 1a, the LIDAR system 100 may, for example, include one or more LIDAR devices 102, in accordance with an embodiment of the disclosure. A LIDAR device 102 may, for example, correspond to/include/be associated with a LIDAR camera. The LIDAR device(s) 102 may, for example, be associated with one or more coverage regions 104 (e.g., referable to as/corresponding to “field of illumination” in accordance with embodiment(s) of the disclosure), in accordance with an embodiment of the disclosure. Moreover, one or more overlap areas 106 may be defined based on the coverage region(s) 104, in accordance with an embodiment of the disclosure.

In one embodiment, the LIDAR system 100 may, for example, include a plurality of LIDAR devices 102. In one specific example, in accordance with an embodiment of the disclosure, the LIDAR system 100 may, for example, include four LIDAR devices (e.g., a first LIDAR device 102a, a second LIDAR device 102b, a third LIDAR device 102c and a fourth LIDAR device 102d). In one specific example, the first LIDAR device 102a may be a first LIDAR camera, the second LIDAR device 102b may be a second LIDAR camera, the third LIDAR device 102c may be a third LIDAR camera and the fourth LIDAR device 102d may be a fourth LIDAR camera.

The LIDAR device(s) 102 may, for example, be carried by the vehicle 100a, in accordance with an embodiment of the disclosure. Specifically, the LIDAR device(s) 102 may, for example, be positioned/arranged on the vehicle 100a in a manner such that one or more coverage regions 104 in association with the vehicle 100a (e.g., around the vehicle 100a) may be defined, in accordance with an embodiment of the disclosure. More specifically, each LIDAR device 102a/102b/102c/102d may be associated with a coverage region such that the coverage region(s) 104 cover (e.g., substantially surround/completely surround) the vehicle 100a, in accordance with an embodiment of the disclosure. Yet more specifically, light (e.g., laser-based light) communicated (e.g., emitted/transmitted/fired) by a LIDAR device 102 may be associated with a coverage region, in accordance with an embodiment of the disclosure.

In one specific example, in one embodiment, the first LIDAR device 102a may be associated with a first coverage region 104a, the second LIDAR device 102b may be associated with a second coverage region 104b, the third LIDAR device 102c may be associated with a third coverage region 104c and the fourth LIDAR device 102d may be associated with a fourth coverage region 104d, in accordance with an embodiment of the disclosure.

In yet a specific example, in one embodiment, the first coverage region 104a may be based on light (e.g., laser beam) communicated (e.g., transmitted) and/or detectable by the first LIDAR device 102a, the second coverage region 104b may be based on light (e.g., laser) communicated (e.g., transmitted) and/or detectable by the second LIDAR device 102b, the third coverage region 104c may be based on light (e.g., laser) communicated (e.g., transmitted) and/or detectable by the third LIDAR device 102c and the fourth coverage region 104d may be based on light (e.g., laser) communicated (e.g., transmitted) and/or detectable by the fourth LIDAR device 102d, in accordance with an embodiment of the disclosure.

As shown, in one embodiment, one or more overlap areas 106 may be defined based on the coverage region(s) 104, in accordance with an embodiment of the disclosure. In one example, based on the first and second coverage regions 104a/104b, a first overlap area 106a may be defined. In another example, based on the first and fourth coverage regions 104a/104d, a second overlap area 106b may be defined. In yet another example, based on the second and third coverage regions 104b/104c, a third overlap area 106c may be defined. In yet a further example, based on the third and fourth coverage regions 104c/104d, a fourth overlap area 106d may be defined.

The overlap area(s) 106 could, for example, be associated with the earlier mentioned (additional/more) ranging information (e.g., additional ranging information), in accordance with an embodiment of the disclosure. For example, light communicated from the one LIDAR device 102 may be a basis for detection by another LIDAR device 102 (e.g., one LIDAR device 102 may be configured to detect light based on light communicated from another LIDAR device 102) in association with the overlap area(s) 106, in accordance with an embodiment of the disclosure. In one specific example, the second LIDAR device 102b may be configured to detect light (e.g., reflected light) based on light emitted from the first LIDAR device 102a in association with the first overlap area 106a. In another specific example, the fourth LIDAR device 102d may be configured to detect light (e.g., reflected light) based on light emitted from the first LIDAR device 102a in association with the second overlap area 106b. In yet another specific example, the third LIDAR device 102c may be configured to detect light (e.g., reflected light) based on light emitted from the second LIDAR device 102b in association with the third overlap area 106c. In yet another further specific example, the fourth LIDAR device 102d may be configured to detect light (e.g., reflected light) based on light emitted from the third LIDAR device 102c in association with the fourth overlap area 106d.

It is contemplated that, in accordance with an embodiment of the disclosure, additional ranging information may be in relation to/associated with/correspond to/include data based on, for example, time of flight measurement. Appreciably, detection of light may, for example, be associated with measurement of time of flight, in accordance with an embodiment of the disclosure.

It is contemplated that it would, for example, be helpful/useful to facilitate reliability (e.g., accuracy) for such detection of light (e.g., in association measurement of time of flight), in accordance with embodiment(s) of the disclosure. It is generally contemplated that such facilitation may be by manner of synchronization of the LIDAR device(s) 102, in accordance with an embodiment of the disclosure.

As discussed earlier, it is contemplated that one possible manner may, for example, be by use of dedicated optical fiber(s) which the present disclosure contemplates, though possibly feasible, may be less than ideal in terms of practical implementation (e.g., possible added system complexities and/or cost inefficiencies etc.).

In this regard, the present disclosure contemplates, as an alternative to the possibility of use of dedicated optical fiber(s), a synchronization strategy, based on an example implementation 100b in accordance with an embodiment of the disclosure, as will be discussed in further detail with reference to FIG. 1b hereinafter.

Referring to FIG. 1b, an example implementation 100b in association with the LIDAR system 100 is shown, in accordance with an embodiment of the disclosure. Specifically, FIG. 1b shows an example implementation 100b in association with the above-mentioned synchronization strategy, in accordance with an embodiment of the disclosure.

As mentioned earlier, the LIDAR system 100 may, for example, include one or more LIDAR devices 102 which may be configured to measure time of flight, in accordance with an embodiment of the disclosure. As shown, the LIDAR device(s) 102 may, for example, be configured to measure time of flight in association with a target 100c, in accordance with an embodiment of the disclosure.

In the context of the example implementation 100b, the LIDAR devices 102 may include a first LIDAR device 102a and a second LIDAR device 102b. In one example, the first LIDAR device 102a may be an active device and the second LIDAR device 102b may be a passive device, in accordance with an embodiment of the disclosure. In another example, the first LIDAR device 102a may be a passive device and the second LIDAR device 102b may be an active device, in accordance with an embodiment of the disclosure.

Appreciably, a first overlap area 106a may, for example, be defined based on the first LIDAR device 102a and the second LIDAR device 102b, in accordance with an embodiment of the disclosure. Moreover, additional ranging information may, for example, possibly be derived/obtained in association with the first overlap area 106a, in accordance with an embodiment of the disclosure. Furthermore, in one specific example, the second LIDAR device 102b may be configured to detect light (e.g., reflected light) based on light emitted from the first LIDAR device 102a in association with the first overlap area 106a

In the context of the example implementation, it is contemplated that in one specific example, light 110a, communicated from the first LIDAR device 102a, which may be in/fall within the first overlap area 106a, may be reflected off target 100c and reflected light 110b (e.g., first light reflected from the target 100c) may be detected/captured by the second LIDAR device 102b such that the possibility of deriving/obtaining, for example, additional ranging information may be facilitated, in accordance with an embodiment of the disclosure. It is appreciable that the first LIDAR device 102a may, for example, be further configured to detect/capture reflected light 110c (e.g., second light reflected from the target 100c), in accordance with an embodiment of the disclosure.

Further in the context of the example implementation 100b, the LIDAR system 100 may, for example, further include a synchronization module 108, in accordance with an embodiment of the disclosure.

The synchronization module 108 may, for example, be coupled to the LIDAR device(s) 102, in accordance with an embodiment of the disclosure. For example, the synchronization module 108 may be coupled to one or both of the first and second LIDAR devices 102a/102b. In one specific example, the synchronization module 108 may be coupled to the first LIDAR device 102a and the second LIDAR device 102b.

In one embodiment, the synchronization module 108 may, for example, include one or both of a hub portion 108a and a computing portion 108b. In one example, the synchronization module 108 may, optionally, include a hub portion 108a, in accordance with an embodiment of the disclosure. In another example, the synchronization module 108 may include a computing portion 108b, in accordance with an embodiment of the disclosure. In yet another example, the synchronization module 108 may include the hub portion 108a and the computing portion 108b, in accordance with an embodiment of the disclosure.

In one embodiment, the hub portion 108a may be coupled to the computing portion 108b, in accordance with an embodiment of the disclosure. Moreover, the first and second LIDAR devices 102a/102b may, for example, be coupled to the hub portion 108a.

Coupling may, for example, be by manner of one or both of wired coupling and wireless coupling. For example, the LIDAR device(s) 102 may be coupled (e.g., by manner of wired coupling and/or wireless coupling) to the synchronization module 108 via a communication channel/network (e.g., Ethernet). In one specific example, the first and second LIDAR devices 102a/102b may be coupled (e.g., by manner of wired coupling and/or wireless coupling) to the hub portion 108a via a communication channel/network (e.g., Ethernet). In another specific example, the first and second LIDAR devices 102a/102b may be coupled (e.g., by manner of wired coupling and/or wireless coupling) to the computing portion 108b via a communication channel/network (e.g., Ethernet). In yet another specific example, the first and second LIDAR devices 102a/102b may be coupled (e.g., by manner of wired coupling and/or wireless coupling) to the hub portion 108a and the computing portion 108b via a communication channel/network (e.g., Ethernet). In yet another specific example, the first and second LIDAR devices 102a/102b may possibly be coupled (e.g., by manner of wired coupling and/or wireless coupling) to each other via a communication channel/network (e.g., Ethernet).

The hub portion 108a may, for example, correspond to a switch (e.g., a hardware-based switch and/or a software-based switch) which may be configured to, for example, facilitate the possibility of switching between the first and second LIDAR devices 102a/102b, if necessary/desired. For example, in one embodiment, the first LIDAR device 102a may initially be an active device and the second LIDAR device 102b may initially be a passive device, and the hub portion 108 may be configured to communicate one or more switching signals such that the first LIDAR device 102a may be switched to be a passive device and the second LIDAR device 102b may be switched to be an active device. In one example, the switching signal(s) may be generated by the computing portion 108b and communicated from the computing portion 108b to the hub portion 108a. In another example, the switching signal(s) may be generated by, and communicated from, the hub portion 108a. In yet another example, the switching signal(s) may be generated by, and communicated from, one or both of the hub portion 108a and the computing portion 108b.

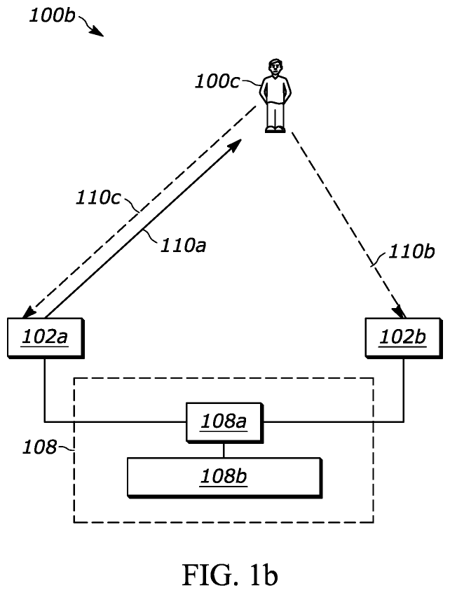

The computing portion 108b may, for example, correspond to a processor (e.g., a hardware-based processor) which may, for example, be configured to perform one or more processing tasks in association with the above-mentioned synchronization strategy, as will be discussed later in further detail with reference to FIG. 2, in accordance with an embodiment of the disclosure. It is contemplated that the synchronization strategy may be useful/helpful in facilitating (e.g., improving/ensuring) accuracy in association with the earlier mentioned possibility of deriving/obtaining, for example, additional ranging information, in accordance with an embodiment of the disclosure. In this regard, the computing portion 108b may, for example, be configured to perform tasks in association with one or both of the switching signal(s) and the above-mentioned synchronization strategy (e.g., task(s) associated with the switching signal(s) and/or task(s) associated with a synchronization strategy). In one embodiment, the computing portion 108b may be configured to perform one or more tasks in association with the above-mentioned synchronization strategy. In another embodiment, the computing portion 108b may be configured to perform one or more tasks in association with the switching signal(s). In yet another embodiment, the computing portion 108b may be configured to perform one or more tasks in association with the above-mentioned synchronization strategy and the switching signal(s).

Generally, in the context of the example implementation 100b, an active device (e.g., the first LIDAR device 102a) may be configured to communicate (e.g., emit/transmit) light (e.g., firing of a laser beam) 110a toward the target 100c whereas a passive device (e.g., the second LIDAR device 102b) may be configured to detect light reflected 110b from the target 100c. In one specific example, an active device (e.g., the first LIDAR device 102a) may be configured to communicate (e.g., emit/transmit) light (e.g., firing of a laser beam) toward the target 100c and detect light reflected 110c from the target 100c, whereas a passive device (e.g., the second LIDAR device 102b) does not communicate light but is simply configured to detect light reflected from the target 100c. In this specific example, light reflected 110c/110b from the target 100c may be detected by both the active and passive devices, but only the active device may be capable of communicating light toward the target 100c.

Earlier mentioned, the computing portion 108b may, for example, be configured to perform one or more processing tasks in association with the above-mentioned synchronization strategy. This will be discussed in further detail with reference to FIG. 2, in accordance with an embodiment of the disclosure, hereinafter.

Specifically, FIG. 2 depicts an example of the above-mentioned synchronization strategy 200 (simply referred to as “synchronization strategy 200” hereinafter) in association with the example implementation 100b, in accordance with an embodiment of the disclosure.

Referring to FIG. 2, in an example situation, the synchronization module 108 may, for example, correspond to an apparatus which may include the aforementioned computing portion 108b (e.g., a processor), in accordance with an embodiment of the disclosure. The computing portion 108b may, for example, be configured to perform one or more processing tasks in association with the synchronization strategy 200. The synchronization strategy 200 may, for example, include one or both of a first synchronization stage (e.g., a coarse synchronization stage) and a second synchronization stage (e.g., a fine synchronization stage), in accordance with an embodiment of the disclosure. In one embodiment, the synchronization strategy 200 may, for example, include the first synchronization stage and the second synchronization stage. The first synchronization stage may, for example, be referable to as an initial synchronization stage and the second synchronization stage may, for example, be referable to as a subsequent synchronization stage, in accordance with an embodiment of the disclosure.

In this regard, in the example situation, the computing portion 108b may, for example, be configured to perform a first set of processing tasks in association with the initial synchronization stage (e.g., coarse synchronization) and/or perform a second set of processing tasks in association with the subsequent synchronization stage (e.g., fine synchronization), in accordance with an embodiment of the disclosure.

Moreover, in the example situation, a first LIDAR camera 202a (e.g., which may be an example of the earlier mentioned first LIDAR device 102a) and a second LIDAR camera 202b (e.g., which may be an example of the earlier mentioned second LIDAR device 102b) may be connected via Ethernet (e.g., an example of the earlier mentioned communication network) to a central computational unit (e.g., which may correspond to the earlier mentioned computing portion 108b), according to an embodiment of the disclosure. One or both of the first LIDAR camera 202a and the second LIDAR camera 202b (i.e., the first LIDAR camera 202a and/or the second LIDAR camera 202b) may be configured to communicate (e.g., fire) light such as a laser beam (referable simply to as “laser” hereinafter).

In the example situation, the computing portion 108b may be configured to perform the first set of processing tasks (i.e., in association with the initial synchronization stage) such that the first LIDAR camera 202a may, for example, be configured to fire a laser and the second LIDAR camera 202b may, for example, be simply configured for detection/capturing/receiving (e.g., of reflected light), in accordance with an embodiment of the disclosure. It is appreciable that the first LIDAR camera 202a may, for example, further be configured for detection/capturing/receiving (e.g., of reflected light) in addition to firing of laser, in accordance with an embodiment of the disclosure. In this regard, it is appreciable that the first LIDAR camera 202a may be considered to be a firing (e.g., of a laser) camera and may hence be considered to be an active camera (e.g., corresponding to the earlier mentioned active device) and the second LIDAR camera 202b which is, for example, configured for simply detection/capturing/receiving may, for example, be considered to be a passive camera (e.g., corresponding to the earlier mentioned passive device), in accordance with an embodiment of the disclosure. It is to be appreciated that, as a possible alternative, the second LIDAR camera 202b may possibly, for example, correspond to an active camera and the first

LIDAR camera 202a may possibly, for example, correspond to a passive camera, in accordance with an embodiment of the disclosure.

With regard to the initial synchronization stage, in the example situation, the first and second LIDAR cameras 202a/202b may possibly be synchronized by, for example, manner of Precision time protocol (PTP), in accordance with an embodiment of the disclosure. It is contemplated that PTP (e.g., associable with IEEE 1588-2008 which may define a protocol enabling precise synchronization of clocks in measurement and control systems) may possibly facilitate time-based synchronization across the Ethernet. It is further contemplated that such time-based synchronization may possibly be associated with, for example, an accuracy of up to 20 to 100 nano seconds (nS). It is yet further contemplated that such accuracy may possibly be inadequate for the purpose of precision ranging (e.g., it is contemplated that an inaccuracy of 20 nS may possibly translate to a range uncertainty of 3 meters). Moreover, it is yet further contemplated that such accuracy may be sufficiently adequate for the purpose of firing laser from an active camera (e.g., the first LIDAR camera 202a) and initiating (e.g., simultaneously initiating) detection/capturing of reflected light associated with an overlap area 106 (e.g., the first overlap area 106a) by a passive camera (e.g., the second LIDAR camera 202b). Appreciably, reflected light associated with an overlap area 106 (e.g., the first overlap area 106a) may, for example, refer to light in/falling within the overlap area 106 (e.g., in/falling within the first overlap area 106a). For example, the first overlap area 106a may be representative of a passive camera (e.g., the second LIDAR camera 202b) which field of view (e.g., detection range/capturing range associated with the passive camera) may be considered to overlap a field of illumination of the active camera (e.g., the first LIDAR camera 202a). Such field of illumination may, for example, correspond to/include/be associated with the aforementioned a coverage region 104 (e.g., the first coverage region 104a), in accordance with an embodiment of the disclosure. Moreover, an overlap area 106 (e.g., the first overlap area 106a) may, for example, refer to/correspond to an overlap in association with the field of view associated with the passive camera and field of illumination associated with the active camera, in accordance with an embodiment of the disclosure.

Appreciably, in regard to the initial synchronization stage, although additional ranging information may be possible in view of detection of reflected light associated with an overlap area 106 by a passive camera, it is contemplated that inadequacies concerning precision ranging may be possible. In this regard, the computing portion 108 may, for example, be further configured to perform the second set of processing tasks (i.e., in association with the subsequent synchronization stage) such that processing tasks associated with adjustment/fine-tuning (e.g., fine-tuning/adjustment-based processing) in association with the passive camera may be performed, in accordance with an embodiment of the disclosure.

Specifically, in the example situation, the computing portion 108b may be configured to perform the second set of processing tasks (i.e., in association with the subsequent synchronization stage) such that the passive camera (e.g., the second LIDAR camera 202b) may be adjusted/fine-tuned with respect to/based on the active camera, in accordance with an embodiment of the disclosure.

With regard to the subsequent synchronization stage, the present disclosure contemplates that the active camera may be capable of returning/determining/deriving an accurate point cloud 203 since the active camera may be capable of determining substantially accurate (preferably, accurate) timing relationship between light transmission 110a (e.g., firing of laser) and light reception 110c (e.g., detection of light reflected from a target 100c) and the passive camera may detect/determining returning light 110b (e.g., detection of light reflected from a target 100c).

In this regard, it is contemplated that the active camera may, for example, be associated with an accurate point cloud 203, in accordance with an embodiment of the disclosure. For example, the active camera may be capable of determining an accurate point cloud 203 (e.g., in association with/based on light reflected from a target 100c), in accordance with an embodiment of the disclosure.

Moreover, in this regard, it is contemplated that the passive camera may only be capable of determining an estimate (e.g., a rough estimate) in association with light transmission. For example, angular direction of received light may possibly be determined by the passive camera but accurate time of flight (or a reasonably accurate time of flight) may possibly not be capable of being determined and, therefore, the passive camera may possibly ascertaining/determining polar angle(s) associated with a target 100c but may possibly have issue(s) (e.g., uncertainty) concerning determination of distance. It is contemplated that such uncertainty may possibly be remedied by manner of, for example, the subsequent synchronization stage (e.g., fine synchronization) as will be discussed, based on an example scenario, in accordance with an embodiment of the disclosure, in further detail hereinafter.

It is contemplated that the example scenario may, for example, relate to the subsequent synchronization stage (e.g., fine synchronization) being performed/done on point cloud level, in accordance with an embodiment of the disclosure.

Specifically, in the example scenario, it is generally contemplated that the active camera may, for example, be capable of determining a substantially accurate (preferably, accurate) time of flight whereas the passive camera may, for example, be capable of determining an estimated time of flight, in accordance with an embodiment of the disclosure. Accordingly, the active camera may, for example, be associated with a time-of-flight measurement capable of being used as a reference (e.g., an accurate point cloud 203), in accordance with an embodiment of the disclosure. It is contemplated that the accurate point cloud 203 may, for example, also correspond to/referable to as a reference point cloud 203 which may include at least one reference cloud point 204, in accordance with an embodiment of the disclosure.

More specifically, in the example scenario, it is further generally contemplated that fine synchronization may, for example, be associated with/include fine synchronization of coarse estimate concerning time of flight determined by the passive camera may be refined/fine-tuned by manner of determining an adjustment/fine-tuning factor with regard to the estimated time-of-flight (e.g., coarse estimate of time-of-flight). The adjustment/fine-tuning factor may, for example, correspond to/include/be associated with a time correction factor (e.g., time correction to coarse estimate of time-of-flight determined by the passive camera), in accordance with an embodiment of the disclosure. The adjustment/fine-tuning factor may, for example, be optimized such that point(s) in a point cloud 206 associated with the passive camera may optimally match (e.g., best match) with point(s) in a point cloud 203 associated with the active camera, in accordance with an embodiment of the disclosure. It is contemplated that, in one embodiment, matching of point(s) in the point cloud 206 associated with the passive camera with point(s) in the point cloud 203 associated with the active camera may, for example, be applicable in respect of a spatial region where field of view of the passive camera and field of view of the active camera overlap (e.g., the first overlap area 106a).

Yet more specifically, in the example scenario, it is contemplated that detection by the passive camera may, for example, be associated with a point cloud (e.g., corresponding to/referable to as “an estimate point cloud”) 206 which may include a plurality of estimate cloud points (e.g., a first point 206a and a second point 206b), in accordance with an embodiment of the disclosure. At least one of the estimate cloud points detected by the passive camera may, for example, coincide/be similarly detected by the active camera. For example, the first point 206a (e.g., detected by the passive camera) may be associated with (e.g., coinciding/similarly detected) with the reference cloud point 204 (e.g., detected by the active camera), in accordance with an embodiment of the disclosure. The present disclosure contemplates that time of flight in association with the passive camera may, for example, be adjusted/fine-tuned based on location matching (e.g., location associated with the reference cloud point 204 may match for both the active and passive cameras), in accordance with an embodiment of the disclosure. Based on such adjustment/fine-tuning, it is appreciable that the range(s) associated with the passive camera may, for example, be considered to be accurate (or, at least substantially improved), in accordance with an embodiment of the disclosure. Specifically, for example, adjustment/fine-tuning may be by manner of matching the first point 206a with the reference cloud point 204 to determine a location (e.g., location associated with the first point 206a may be matched with location associated with the reference cloud point 204) which may be usable for adjusting/fine-tuning the estimated time of flight measured by the passive camera so that time of flight measurement by the passive camera may, for example, be referenced to that of the active camera (e.g., which time of flight measurement may be considered to be substantially accurate), in accordance with an embodiment of the disclosure. It is contemplated that by manner of fine-tuning/adjustment based on matching of one cloud point (e.g., the first point 206a) detected by the passive camera which may be associated with a location which is the same/similar to that of the reference cloud point 204 (i.e., matching based on a common location which may be associated with the reference cloud point 204 and which may be associated with the first point 206a), range(s) associated with the remaining cloud points (e.g., the second point 206b) detected by the passive camera may be adjusted/fine-tuned accordingly. In this regard, it is contemplated that the range(s) associated with the passive camera may be considered to be accurate/substantially improved after fine synchronization since time-of-flight correction/adjustment/fine-tuning, as discussed earlier, may, for example, be considered to be common to the point(s) (e.g., the first point 206a and/or the second point 206b) of the point cloud 206 associated with the passive camera, in accordance with an embodiment of the disclosure. In this regard, it is appreciable that, in one embodiment, the adjustment/fine-tuning factor may, for example, correspond to/include/be associated with a time correction factor which may be based on matching of a cloud point (e.g., the first point 206a) detected by the passive camera with a reference cloud point 204 (e.g., detected by the active camera) where the location associated with the point cloud detected by the passive camera and location associated with the reference cloud point 204 may be considered to be common.

Generally, in the example situation, it is to be appreciated that the initial synchronization stage may be associated with/include firing laser from an active camera (e.g., the first LIDAR camera 202a) and initiating (e.g., simultaneously initiating) detection/capturing of reflected light associated with an overlap area 106 (e.g., the first overlap area 106a) by a passive camera (e.g., the second LIDAR camera 202b), in accordance with an embodiment of the disclosure.

Further generally, in the example situation, it is to be appreciated that the subsequent synchronization stage may be associated with/include matching as between an active camera (e.g., the first LIDAR camera 202a) and a passive camera (e.g., the second LIDAR camera 202b) so as to determine an adjustment/fine-tuning factor, in accordance with an embodiment of the disclosure.

In view of the foregoing, it is appreciable that the present disclosure contemplates, in general, an apparatus which may, for example, correspond to a synchronization module 108 as discussed earlier in the context of the example implementation 100b, in accordance with an embodiment of the disclosure. In this regard, the apparatus may, for example, analogously be labeled as “108” in accordance with an embodiment of the disclosure.

The apparatus 108 may, for example, be suitable for facilitating synchronization of an active device (e.g., a first LIDAR device 102a such as a first LIDAR camera 202a) and a passive device (e.g., a second LIDAR device 102b such as a second LIDAR camera 202b), in accordance with an embodiment of the disclosure.

The apparatus 108 may, for example, include a processor (e.g., corresponding to the computing portion 108b) which may be coupled to one or both of the active device and the passive device (i.e., the active device and/or the passive device; at least one of the active device and the passive device), in accordance with an embodiment of the disclosure.

The processor may, for example, be configured to perform one or both of a first set of processing tasks and a second set of processing tasks (i.e., a first set of processing tasks and/or a second set of processing tasks; at least one or a first set of processing tasks and a second set of processing tasks), in accordance with an embodiment of the disclosure.

The first set of processing tasks may, for example, be associated with a first synchronization stage (e.g., as discussed earlier in the context of the synchronization strategy 200, in accordance with an embodiment of the disclosure) and the second set of processing tasks may, for example, be associated with a second synchronization stage (e.g., as discussed earlier in the context of the synchronization strategy 200, in accordance with an embodiment of the disclosure).

In one embodiment, the first synchronization stage may be associated with coarse synchronization of the active device and passive device. Moreover, coarse synchronization may, for example, include coarse time synchronization of the active and passive devices, in accordance with an embodiment of the disclosure. In one embodiment, the second synchronization stage may be associated with fine synchronization of the active device and passive device. Moreover, fine synchronization may, for example, include fine time synchronization of the active and passive devices, in accordance with an embodiment of the disclosure.

In one embodiment, the active device may, for example, correspond to a first LIDAR device 102a capable of one or both of communication of light (e.g., transmission of light such as firing of laser) and detection (i.e., communication of light and/or detection; at least one of communicating light and detection). The passive device may, for example, correspond to a second LIDAR device 102b which may be capable of detection.

In one embodiment, the apparatus 108 may, for example, further include, as an option, a switching part (e.g., corresponding to the hub portion 108a) which may be coupled to the processor. Moreover, the switching part may, for example, be further coupled to the active device and the passive device. In one example, the switching part may be configured to facilitate switching between the active device and the passive device such that the active device may be switched to become a passive device and the passive device may be switched to become an active device.

In one embodiment, coarse time synchronization of the active device and passive device may, for example, include communication of light from an active device toward a target 100c and initiating capturing of light reflected from/by/off the target by the passive device. Capturing of light reflected from the target 100c may, for example, be associated with an overlap area (e.g., a first overlap area 106a) between a coverage region (e.g., a first coverage region 104a) associated with the active device and another coverage region (e.g., a second coverage region 104b) associated with the passive device. Moreover, coarse time synchronization of the active device and the passive device may, for example, be based on Precision time protocol.

In one embodiment, fine time synchronization of the active device and passive device may, for example, include matching as between the active device and the passive device in a manner so as to determine at least one fine-tuning factor. In one example, the fine-tuning factor may be determined by manner of point-cloud based matching in association with the active device and the passive device. It is contemplated that the active device may, for example, be capable of determining a reference point cloud 203 which may, for example, include at least one reference cloud point 204. It is further contemplated that the passive device may be capable of determining an estimate point cloud 206 which may include a plurality of estimate cloud points (e.g., a first point 206a and a second point 206b). It is yet further contemplated that at least one estimate cloud point (e.g., the first point 206a) may, for example, be capable of being associated with the reference cloud point(s) 204. In a specific example, the fine-tuning factor may be determined based on matching at least one estimate cloud point (e.g., the first point 206a) with the reference cloud point 204. In a more specific example, the reference cloud point 204 may be associated with a location and the estimate cloud point (e.g., the first point 206a) may be associated with a location which corresponds to the location associated with the reference cloud point 204 (e.g., the estimate cloud point and the reference cloud point 204 may correspond to/be in reference to a common location), and time of flight in association with the passive device may be fine-tuned by manner of location matching based on the reference cloud point 204 and the estimate point cloud (e.g., the first point 206a may be matched to the reference cloud point 204 by virtue of the location associated with the first point 206a corresponding to the same location as the location associated with the reference cloud point 204).

In one embodiment, it is contemplated that fine synchronization may, for example, be subsequent to coarse synchronization (e.g., fine synchronization may be performed/may occur after coarse synchronization).

Appreciably, in the above manner, information/data collected may possibly be increased (e.g., information/data associated with the overlap area(s) 106) and/or metrics such as range precision may possibly be improved/optimized, in accordance with embodiment(s) of the disclosure. Moreover, higher confidence of detection and/or enhanced size estimation of object(s) may possibly be facilitated, in accordance with embodiment(s) of the disclosure.

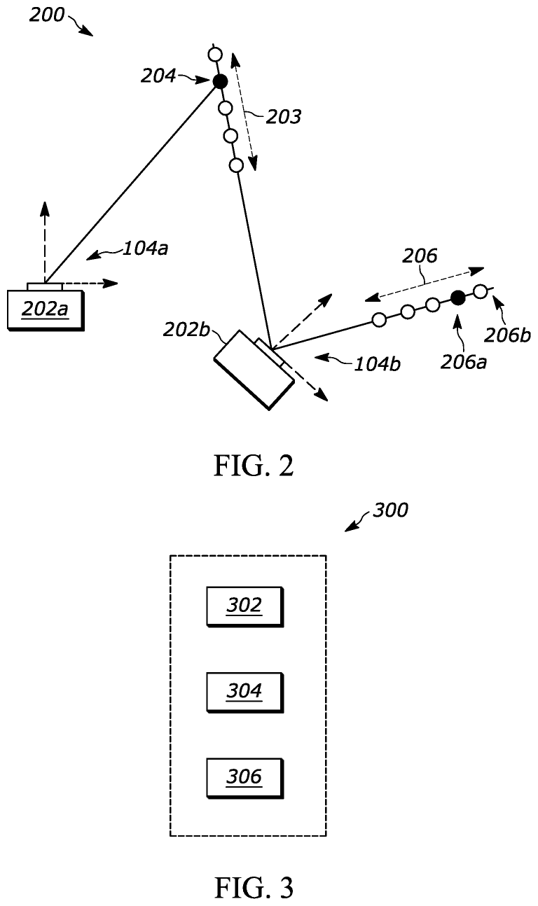

Referring to FIG. 3, a processing method 300 is shown, in accordance with an embodiment of the disclosure. The processing method 300 may, for example, be associated with the LIDAR system 100, in accordance with an embodiment of the disclosure. In one specific example, the processing method 300 may be associated with the earlier discussed synchronization strategy 200, in accordance with an embodiment of the disclosure.

As shown, the processing method 300 may, for example, include one or both of a coarse synchronization step 302 and a fine synchronization step 304, in accordance with an embodiment of the disclosure. The processing method 300 may, for example, further include, as an option, a switching step 306, in accordance with an embodiment of the disclosure.

In one embodiment, the processing method 300 may, for example, include a coarse synchronization step 302. In another embodiment, the processing method 300 may, for example, include a fine synchronization step 304. In another embodiment, the processing method 300 may, for example, include a switching step 306. In yet another embodiment, the processing method 300 may, for example, include a coarse synchronization step 302 and a fine synchronization step 304. In yet another further embodiment, the processing method 300 may, for example, include one or both of a coarse synchronization step 302 and a fine synchronization step 304, and a switching step 306. In yet another further embodiment, the processing method 300 may, for example, include a coarse synchronization step 302, a fine synchronization step 304 and a switching step 306.

It is contemplated that the processing method 300 may, for example, include any one of a coarse synchronization step 302, a fine synchronization step 304 and a switching step 306, or any combination thereof (i.e., a coarse synchronization step 302, a fine synchronization step 304 and/or a switching step 306), in accordance with an embodiment of the disclosure.

With regard to the coarse synchronization step 302, a first set of processing tasks in association with the initial synchronization stage may be performed (e.g., by the computing portion 108b), in accordance with an embodiment of the disclosure. For example, as discussed earlier in the context of the example situation, it is to be generally appreciated that the initial synchronization stage may be associated with/include firing laser from an active camera (e.g., the first LIDAR camera 202a) and initiating (e.g., simultaneously initiating) detection/capturing of reflected light associated with an overlap area 106 (e.g., the first overlap area 106a) by a passive camera (e.g., the second LIDAR camera 202b), in accordance with an embodiment of the disclosure.

With regard to the fine synchronization step 304, a second set of processing tasks in association with the subsequent synchronization stage may be performed (e.g., by the computing portion 108b), in accordance with an embodiment of the disclosure. For example, as discussed earlier in the context of the example situation, it is to be generally appreciated that the subsequent synchronization stage may be associated with/include matching as between an active camera (e.g., the first LIDAR camera 202a) and a passive camera (e.g., the second LIDAR camera 202b) so as to determine an adjustment/fine-tuning factor, in accordance with an embodiment of the disclosure.

With regard to the switching step 306, switching (e.g., performed by the hub portion 108a) between an active device (e.g., the first LIDAR device 102a) and a passive device (e.g., the second LIDAR device 102b) may, for example, be facilitated, in accordance with an embodiment of the disclosure. In an example, as discussed earlier, a hub portion 108a (which may, for example, correspond to a switch such as a hardware-based switch and/or a software-based switch) may be configured to, for example, facilitate the possibility of switching between the first and second LIDAR devices 102a/102b, if necessary/desired. In a more specific example, in one embodiment, the first LIDAR device 102a may initially be an active device and the second LIDAR device 102b may initially be a passive device, and the hub portion 108 may be configured to communicate a switching signal such that the first LIDAR device 102a may be switched to be a passive device and the second LIDAR device 102b may be switched to be an active device.

The present disclosure further contemplates a computer program (not shown) which may include instructions which, when the program is executed by a computer (not shown), cause the computer to carry out the coarse synchronization step 302, the fine synchronization step 304 and/or the switching step 306 as discussed with reference to the processing method 300.

The present disclosure yet further contemplates a computer readable storage medium (not shown) having data stored therein representing software executable by a computer (not shown), the software including instructions, when executed by the computer, to carry out the coarse synchronization step 302, the fine synchronization step 304 and/or the switching step 306 as discussed with reference to the processing method 300.

In view of the foregoing, it is appreciable that the present disclosure generally contemplates a processing method 300, in accordance with an embodiment of the disclosure.

The processing method 300 may, for example, be suitable for facilitating synchronization (e.g., based on the synchronization strategy 200 as discussed earlier in accordance with an embodiment of the disclosure) between an active device (e.g., a first LIDAR device 102a such as a first LIDAR camera 202a) and a passive device (e.g., a second LIDAR device 102b such as a second LIDAR camera 202b), in accordance with an embodiment of the disclosure. The processing method 300 may, for example, include a coarse synchronization step 302 and a fine synchronization step 304, in accordance with an embodiment of the disclosure. The coarse synchronization step 302 may, for example, include performing a first set of processing tasks to perform the tasks of communicating light from the active device toward a target 100c and initiating capturing of light reflected from the target 100c by the passive device. The fine synchronization step 304 may, for example, include performing a second set of processing tasks to perform the task of matching as between the active device and the passive device in a manner so as to determine at least one fine-tuning factor.

In one embodiment, the processing method 300 may, for example, further include a switching step 306. The switching step 306 may, for example, include performing one or more processing tasks in association with switching between the active device and the passive device in a manner such that the active device may be switched to become a passive device and the passive device may be switched to become an active device. The active device may, for example, correspond to a first LIDAR device 102a capable of communicating light and/or detection. The passive device may, for example, correspond to a second LIDAR device 102b capable of detection.

Appreciably, in the above manner, information/data collected may possibly be increased (e.g., information/data associated with the overlap area(s) 106) and/or metrics such as range precision may possibly be improved/optimized, in accordance with embodiment(s) of the disclosure. Moreover, higher confidence of detection and/or enhanced size estimation of object(s) may possibly be facilitated, in accordance with embodiment(s) of the disclosure.

It should be appreciated that the embodiments described above may be combined in any manner as appropriate (e.g., one or more embodiments as discussed in the “Detailed Description” section may be combined with one or more embodiments as described in the “Brief Summary” section).

It should be further appreciated by the person skilled in the art that variations and combinations of embodiments described above, not being alternatives or substitutes, may be combined to form yet further embodiments.

In one example, it was earlier discussed that an example scenario may, for example, relate to the subsequent synchronization stage (e.g., fine synchronization) being performed/done on point cloud level, in accordance with an embodiment of the disclosure. Specifically, the example scenario may, for example, relate to subsequent synchronization stage (e.g., fine synchronization) being performed/done directly on point cloud level, in accordance with an embodiment of the disclosure. The present disclosure contemplates another example scenario where fine synchronization may be based on object detection level. In one specific example, in accordance with an embodiment of the disclosure, cloud point(s) associated with both the active and passive cameras may be clustered based on one or more objects and time correction may be adjusted/fine-tuned such that position(s) of the object(s) may align.

In another example, depending on spacing between an active device (e.g., an active LIDAR device) and a passive device (e.g., a passive LIDAR device), and distance to the object(s), one or more other possible benefits may be achieved based on different radiometric condition(s) for the active and passive devices. Examples may include retroflector, stereoscopic ranging, surface orientation and/or backlight condition(s).

In yet another example, the present disclosure contemplates the possibility that in regard to the synchronization module 108, the hub portion 108a may be omitted and the LIDAR device(s) 102 may be coupled (e.g., directly coupled) to the computing portion 108b, in accordance with an embodiment of the disclosure.

The foregoing description shall be interpreted as illustrative and not be limited thereto. One of ordinary skill in the art would understand that certain modifications may come within the scope of this disclosure. Although the different non-limiting embodiments are illustrated as having specific components or steps, the embodiments of this disclosure are not limited to those combinations. Some of the components or features from any of the non-limiting embodiments may be used in combination with features or components from any of the other non-limiting embodiments. For these reasons, the appended claims should be studied to determine the true scope and content of this disclosure.

1. An apparatus suitable for facilitating synchronization of an active device and a passive device, the apparatus comprising:
a processor coupled to at least one of the active device and the passive device, the processor configurable to at least one of:
perform a first set of processing tasks in association with a first synchronization stage; and
perform a second set of processing tasks in association with a second synchronization stage,
wherein the first synchronization stage is associable with coarse synchronization of the active device and passive device, coarse synchronization comprising coarse time synchronization of the active and passive devices, and
wherein the second synchronization stage is associable with fine synchronization of the active device and passive device, fine synchronization comprising fine time synchronization of the active and passive devices.

2. The apparatus according to claim 1,
wherein the active device corresponds to a first LIDAR (light detection and ranging) device capable of at least one of communicating light and detection, and
wherein the passive device corresponds to a second LIDAR device capable of detection.

3. The apparatus according to claim 2,
wherein the first LIDAR device corresponds to a first LIDAR camera and the second LIDAR device corresponds to a second LIDAR camera.

4. The apparatus according to claim 1 further comprising a switching part coupled to the processor, the switching part being further coupled to the active device and the passive device.

5. The apparatus according to claim 4,
wherein the switching part is configurable to facilitate switching between the active device and the passive device such that:
the active device is switched to become a passive device, and
the passive device is switched to become an active device.

6. The apparatus according to claim 1, wherein coarse time synchronization of the active device and passive device comprises communication of light from an active device toward a target and initiating capturing of light reflected from the target by the passive device.

7. The apparatus according to claim 6, wherein capturing of light reflected from the target being associated with an overlap area between a coverage region associated with the active device and another coverage region associated with the passive device.

8. The apparatus according to claim 7, wherein coarse time synchronization of the active device and the passive device is based on Precision time protocol.

9. The apparatus according to claim 1, wherein fine time synchronization of the active device and passive device comprises matching as between the active device and the passive device in a manner so as to determine at least one fine-tuning factor.

10. The apparatus according to claim 9, wherein the fine-tuning factor is determined by manner of point-cloud based matching in association with the active device and the passive device.

11. The apparatus according to claim 10, wherein the active device is capable of determining a reference point cloud comprising at least one reference cloud point.

12. The apparatus according to claim 11, wherein the passive device is capable of determining an estimate point cloud comprising a plurality of estimate cloud points of which at least one is capable of being associated with the reference cloud point.

13. The apparatus according to claim 12, wherein the fine-tuning factor is determined based on matching at least one estimate cloud point with the reference cloud point.

14. The apparatus according to claim 13,
wherein the reference cloud point is associable with a location,
wherein the estimate cloud point is associable with a location which corresponds to the location associated with the reference cloud point, and
wherein time of flight in association with the passive device is fine-tuned by manner of location matching based on the reference cloud point and the estimate point cloud.

15. The apparatus according to claim 1, wherein fine synchronization is subsequent to coarse synchronization.

16. A processing method for facilitating synchronization between an active device and a passive device, the processing method comprising:
a coarse synchronization step comprising performing a first set of processing tasks to perform the tasks of:
communicating light from the active device toward a target, and
initiating capturing of light reflected from the target by the passive device; and
a fine synchronization step comprising performing a second set of processing tasks to perform the task of matching as between the active device and the passive device in a manner so as to determine at least one fine-tuning factor.

17. The processing method according to claim 16, further comprising:
a switching step comprising switching between the active device and the passive device in a manner such that:
the active device is switched to become a passive device, and
the passive device is switched to become an active device.

18. The method according to claim 16,
wherein the active device corresponds to a first LIDAR (light detection and ranging) device capable of at least one of communicating a light source, and detection, and
wherein the passive device corresponds to a second LIDAR device capable of detection.

19. A computer program comprising instructions which, when the program is executed by a computer, cause the computer to carry out at least one of the coarse synchronization step, the fine synchronization step and the switching step according to the processing method of claim 16.

20. A computer readable storage medium having data stored therein representing software executable by a computer, the software including instructions, when executed by the computer, to carry out at least one of the coarse synchronization step, the fine synchronization step and the switching step according to the processing method of claim 16.
